(19) United States
(12) Patent Application Publication
(10) Pub. No.: US 2022/0289193 A1
(43) Pub. Date: Sep. 15, 2022

(54) APPARATUS AND METHOD FOR CONTROLLING VEHICLE

(71) Applicants: HYUNDAI MOTOR COMPANY, Seoul (KR); Kia Corporation, Seoul (KR)

(72) Inventor: Jaesik YANG, Seoul (KR)

(21) Appl. No.: 17/405,324

(22) Filed: Aug. 18, 2021

(30) Foreign Application Priority Data
Mar. 9, 2021 (KR) 10-2021-0030787

(51) Int. Cl. B60W 30/16; G08G 1/0967

(52) U.S. Cl. CPC B60W 30/162; G08G 1/0967; B60W 2540/106; B60W 2554/406; B60W 2554/802; B60W 2520/10; B60W 2555/60; B60W 2720/10

(57) ABSTRACT

A vehicle control apparatus of a host vehicle, may include a driving environment sensor that obtains information on a front vehicle; a communication portion that receives traffic situation information; and a controller that is electrically connected to the driving environment sensor and the communication portion and utilizes the information on the front vehicle and the traffic situation information to determine a cruise driving state of the host vehicle and that, when the vehicle is in the cruise driving state, controls torque of the vehicle so that a torque change corresponding to an opening rate of an accelerator pedal of the host vehicle becomes smaller than a predetermined value.

### CROSS-REFERENCE TO RELATED APPLICATION

The present application claims priority to Korean Patent Application No. 10-2021-0030787 filed on Mar. 9, 2021, the entire contents of which is incorporated herein for all purposes by this reference.

### BACKGROUND OF THE INVENTION

### Field of the Invention

The present invention relates to an apparatus and method for controlling a vehicle which may control cruise driving of the vehicle.

### Description of Related Art

When driving on a road on which there is no blockage or curve, a driver tends to cruise-drive after a vehicle is completely accelerated at a desired speed. However, when a cruise driving time is lengthened, in a case of drivers with weak power, such as the elderly and women, an ankle holding an accelerator pedal is gradually lifted, so that the speed of the vehicle decreases little by little, and in a case of drivers who are unfamiliar with driving, the speed of the vehicle is unintentionally gradually increased because the ankle is strained and thus force is applied to the accelerator pedal. This leads to unnecessary changes in vehicle speed, causing inconvenience of having to check the vehicle speed from time to time while driving.

To reduce the present inconvenience, the vehicle is provided with a cruise driving assistance system, and according to the cruise driving assistance system, when the driver operates a set switch when the vehicle reaches a desired driving speed while driving, thereafter, the vehicle is controlled to travel at a constant speed set by the set switch without stepping on the accelerator pedal.

Such a cruise driving assistance system, when used on a highway, may reduce the driver's fatigue, protect ankle joints and knees, as well as provide an advantage of not having to be aware of a crackdown camera, and in particular, saving fuel.

However, the cruise driving assistance system has a hassle of having to manipulate a set switch for cruise driving, and cannot actively respond to changes in speed limit and traffic volume according to road conditions.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle control apparatus and method in which a driver may maintain cruise driving.

Embodiments are to provide a vehicle control apparatus and method which may improve fuel efficiency during cruise driving.

An exemplary embodiment provides a vehicle control apparatus, including: a driving environment sensor that obtains information on a front vehicle; a communication portion that receives traffic situation information; and a controller that is electrically connected to the driving environment sensor and the communication portion and utilizes the information on the front vehicle and the traffic situation information to determine a cruise driving state of a host vehicle and that, when the host vehicle is in the cruise driving state, controls torque of the host vehicle so that a torque change corresponding to an opening rate of an accelerator pedal of the host vehicle becomes smaller than a predetermined value.

The traffic situation information may include information indicating at least one of a degree of congestion and presence or absence of an accident on a road on which the host vehicle is positioned, and the controller may be configured to determine the cruise driving state of the host vehicle when the degree of congestion according to a type of the road on which the host vehicle is positioned corresponds to a predetermined condition.

The controller may be configured to determine the cruise driving state of the host vehicle upon determining that a distance between the front vehicle and the host vehicle is greater than or equal to a reference distance.

The vehicle control apparatus may further include a vehicle speed sensor configured for detecting a speed of the host vehicle, wherein the controller may be configured to determine the cruise driving state of the host vehicle when the speed of the host vehicle is within a predetermined speed range.

The traffic situation information may include information on a speed limit of the road on which the host vehicle is positioned, the predetermined speed range may include a range between a speed value obtained by adding a first correction speed to the speed limit and a speed value obtained by subtracting a second correction speed from the speed limit, and the first correction speed and the second correction speed may be determined corresponding to the speed limit.

The first correction speed may be less than or equal to the second correction speed.

The first correction speed and the second correction speed may increase as the speed limit increases.

The first correction speed and the second correction speed may have a constant value when the speed limit is less than a predetermined speed.

The controller may be configured to control torque of the host vehicle so that a difference in an opening rate of the accelerator pedal corresponding to a difference between a first torque value and a second torque value in the cruise driving state is smaller than the difference in the opening rate of the accelerator pedal corresponding to the difference between the first torque value and the second torque value if not in the cruise driving state.

The controller may be configured to control torque of the host vehicle so that a torque value corresponding to a first opening rate of the accelerator pedal in the cruise driving state is smaller than a torque value corresponding to the first opening rate of the accelerator pedal if not in the cruise driving state.

Another exemplary embodiment provides a vehicle control method, including: obtaining, by a driving environment sensor, information on a front vehicle; receiving, by a communication portion, traffic situation information; determining, by use of the information on the front vehicle and the traffic situation information, a cruise driving state of a vehicle; and controlling, when the host vehicle is in the cruise driving state, torque of the host vehicle so that a torque change corresponding to an opening rate of an accelerator pedal of the host vehicle becomes smaller than a predetermined value.

The traffic situation information may include information indicating at least one of a degree of congestion and presence or absence of an accident on a road on which the host vehicle is positioned, and the determining of the cruise driving state of the host vehicle may include determining the cruise driving state when the degree of congestion according to a type of the road on which the host vehicle is positioned corresponds to a predetermined condition.

The determining of the cruise driving state of the host vehicle may include, determining the cruise driving state when a distance between the front vehicle and the host vehicle is greater than or equal to a reference distance.

The host vehicle control method may further include detecting, by a vehicle speed sensor, a speed of the host vehicle, wherein the determining of the cruise driving state of the host vehicle may include, when the speed of the host vehicle is within a predetermined speed range, determining the cruise driving state.

The traffic situation information may include information on a speed limit of the road on which the host vehicle is positioned, the predetermined speed range may include a range between a speed value obtained by adding a first correction speed to the speed limit and a speed value obtained by subtracting a second correction speed from the speed limit, and the first correction speed and the second correction speed may be determined corresponding to the speed limit.

The first correction speed may be less than or equal to the second correction speed.

The first correction speed and the second correction speed may increase as the speed limit increases.

The first correction speed and the second correction speed may have a constant value when the speed limit is less than a predetermined speed.

The controlling of the torque of the host vehicle may include controlling torque of the host vehicle so that a difference in an opening rate of the accelerator pedal corresponding to a difference between a first torque value and a second torque value in the cruise driving state is smaller than the difference in the opening rate of the accelerator pedal corresponding to the difference between the first torque value and the second torque value if not in the cruise driving state.

The controlling of the torque of the host vehicle may include controlling torque of the host vehicle so that a torque value corresponding to a first opening rate of the accelerator pedal in the cruise driving state is smaller than a torque value corresponding to the first opening rate of the accelerator pedal if not in the cruise driving state sheet.

Another exemplary embodiment provides a vehicle including the vehicle control apparatus according the embodiment.

Another exemplary embodiment provides a program stored in a computer-readable medium executing the vehicle control method according to the exemplary embodiment of the present invention.

According to the embodiments, it is possible to maintain cruise driving of a vehicle.

According to the embodiments, it is possible to improve fuel efficiency.

According to the embodiments, it is possible to reflect a driver's will to allow cruise driving of a vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram of a vehicle control apparatus according to various exemplary embodiments of the present invention.

FIG. 2 illustrates a flowchart of a vehicle control method according to various exemplary embodiments of the present invention.

FIG. 3 illustrates a view of an inter-vehicle distance from a front vehicle.

FIG. 4 illustrates a graph of a reference inter-vehicle distance between vehicles with respect to a vehicle speed in a vehicle control method according various exemplary embodiments of the present invention.

FIG. 5 illustrates a graph a corrected speed with respect to a speed limit in a vehicle control method according various exemplary embodiments of the present invention.

FIG. 6A, FIG. 6B, FIG. 6C and FIG. 6D illustrate graphs of torque with respect to RPM and APS in a vehicle control method of various exemplary embodiments of the present invention.

FIG. 7 illustrates a graph of an accelerator pedal opening rate during cruise driving and accelerating with respect to a vehicle speed in a vehicle control method of various exemplary embodiments of the present invention.

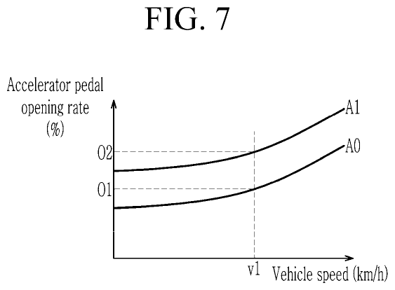

FIG. 8 illustrates a graph of an acceleration time point during cruise driving in a vehicle control method of various exemplary embodiments of the present invention.

FIG. 9A and FIG. 9B illustrate graphs of acceleration and vehicle speed of a vehicle traveling according to a vehicle control method of various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various embodiments of this document will be described with reference to the accompanying drawings. However, it should be understood that technology described in this document is not limited to a specific embodiment and includes various modifications, equivalents, and/or alternatives of an exemplary embodiment of this document. With regard to the description of the drawings, similar reference numerals may be used to refer to similar elements.

In the present document, an expression such as “have,” “may have,” “comprise,” or “may comprise” indicates existence of a corresponding characteristic (e.g., constituent elements such as a numerical value, function, operation, or component) and does not exclude the presence of another characteristic.

In the present document, an expression such as “A or B”, “at least one of A or/and B”, or “one or more of A or/and B” may include all possible combinations of together listed items. For example, “A or B,” “at least one of A and B,” or “one or more of A or B” may indicate all of (1) a case of including at least one A, (2) a case of including at least one B, and (3) a case of including both at least one A and at least one B.

An expression such as “first” and “second” used in the present document may indicate various constituent elements regardless of order and/or importance, is used for distinguishing a constituent element from another constituent element, and does not limit corresponding constituent elements. For example, a first user device and a second user device may represent another user device regardless of order and/or importance. For example, a first constituent element may be referred to as a second constituent element without deviating from the scope described in the present document, and similarly, a second constituent element may be referred to as a first constituent element.

When it is described that a constituent element (e.g., a first constituent element) is “(operatively or communicatively) coupled with/to” or is “connected to” another constituent element (e.g., a second constituent element), it should be understood that the constituent element may be directly connected to the another constituent element or may be connected to the another constituent element through another constituent element (e.g., a third constituent element). However, when it is described that a constituent element (e.g., a first constituent element) is “directly connected” or is “directly accessed” to another constituent element (e.g., a second constituent element), it may be understood that another constituent element (e.g., a third constituent element) does not exist between the constituent element and the other constituent element.

An expression “configured to” used in the present document may be interchangeably used with, for example, “suitable for”, “having the capacity to”, “designed to”, “adapted to”, “made to”, or “capable of” according to a situation. A term “configured to” does not always mean “specifically designed to” in hardware. Alternatively, in any situation, an expression “device configured to” may mean that the device is “capable of” being configured together with another device or component. For example, a “processor configured to perform phrases A, B, and C” may be a generic-purpose processor (e.g., a CPU or application processor) that executes an exclusive processor (e.g., an embedded processor) for performing a corresponding operation or at least one software program stored at a memory device to perform a corresponding operation.

Terms used in the present document are used for describing a specific embodiment and do not limit a range of another exemplary embodiment of the present invention. Unless the context otherwise clearly indicates, words used in the singular include the plural, and the plural includes the singular. Terms used here including a technical or scientific term have the same meaning as that which may be generally understood by a person of common skill in the art. Terms defined in a general dictionary among terms used in the present document may be analyzed as the same meaning as or a meaning similar to that in a context of related technology, and unless it is clearly defined in the present document, the term is not analyzed as having an ideal or excessively formal meaning. In some cases, a term defined in the present document cannot be analyzed to exclude the exemplary embodiments of the present document.

It is understood that the term “vehicle” or “vehicular” or other similar terms as used herein is inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g., fuel derived from resources other than petroleum).

Hereinafter, a vehicle control apparatus and method according to exemplary embodiments will be described with reference to necessary drawings.

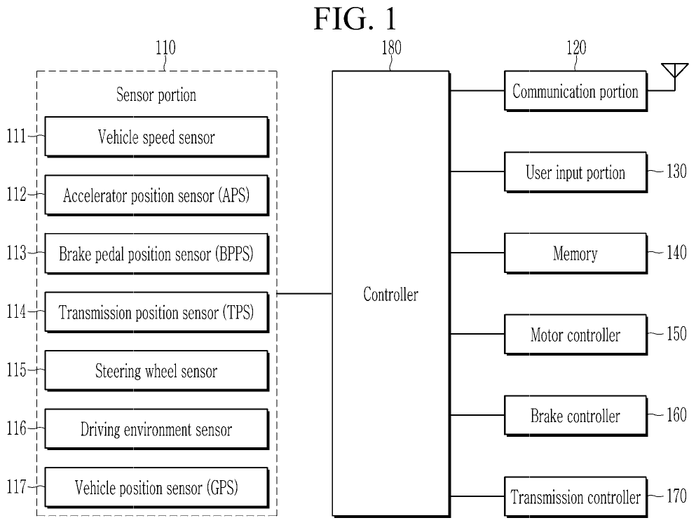

FIG. 1 illustrates a block diagram of a vehicle control apparatus according to various exemplary embodiments of the present invention.

Referring to FIG. 1, a vehicle control apparatus 100 may include a sensor portion 110, a communication portion 120, a user input portion 130, a memory 140, an engine controller 150, a motor controller 160, a brake controller 170, a transmission controller 180, and a controller 190.

The sensor portion 110 may include a vehicle speed sensor 111, an accelerator position sensor (APS) 112, a brake pedal position sensor (BPPS) 113, a transmission position sensor (TPS) 114, a steering wheel sensor 115, a driving environment sensor 116, and a vehicle position sensor 117.

The vehicle speed sensor 111 may detect a vehicle speed. For example, the vehicle speed sensor may be mounted on a vehicle's wheel.

The accelerator position sensor 112 measures a degree to which the driver depresses the accelerator pedal. That is, the accelerator position sensor 112 measures an opening rate value of the accelerator pedal (the degree to which the accelerator pedal is depressed) to provide a signal of the measured position value to the controller 190. When the accelerator pedal is fully depressed, the opening rate of the accelerator pedal may be 100%, and when the accelerator pedal is not depressed, the opening rate of the accelerator pedal may be 0%. Instead of the accelerator position sensor 112, a throttle valve opening detector mounted in an intake passage may be used.

The brake pedal position sensor 113 measures a degree to which the driver depresses the brake pedal. That is, the brake pedal position sensor 113 measures a position value of the brake pedal (the degree to which the brake pedal is depressed) to transmit a signal of the measured position value to the controller 190. When the brake pedal is fully depressed, the position value of the brake pedal may be 100%, and when the brake pedal is not depressed, the position value of the brake pedal may be 0%.

The transmission position sensor 114 detects a gear shifting position, and the steering wheel sensor 115 detects a steering state of the vehicle.

The driving environment sensor 116 detects driving environment information and vehicle state information related to a road on which the vehicle is driving. The driving environment sensor 116 obtains driving environment information through various sensors such as a camera, a radio detecting and ranging (radar), a light detection and ranging (LiDAR), and an ultrasonic wave sensor.

The driving environment sensor 116 extracts shape information and distance information such as lanes, speed limits, traffic signs, surrounding vehicles, pedestrians, and traffic lights from image information obtained through the camera. Furthermore, the driving environment sensor 116 may obtain distance and spatial information for omnidirectional objects (vehicles, pedestrians, and/or obstacles, etc.) through the RADAR, the LiDAR, and the ultrasonic wave sensor.

The vehicle position sensor 117 measures a vehicle's current position. The vehicle position sensor 117 may measure the vehicle position by use of at least one or more of a global positioning system (GPS), dead reckoning (DR), a differential GPS (DGPS), and a carrier phase differential GPS (CDGPS).

The communication portion 120 communicates with a server through a network. The communication portion 120 may communicate with surrounding vehicles and/or road infrastructure. The communication portion 120 may use communication technologies such as wireless Internet, mobile communication, and/or vehicle to everything (V2X). As the wireless Internet technology, wireless LAN (WLAN) (WiFi), wireless broadband (WiBro), and/or Worldwide Interoperability for Microwave Access (WiMAX) may be used, and as the mobile communication technology, code division multiple access (CDMA), global system for mobile communication (GSM), long term evolution (LTE), and/or LTE-Advanced may be used. As the V2X communication technology, vehicle-to-vehicle (V2V) communication, vehicle-to-infrastructure (V2I) communication, vehicle-to-nomadic devices (V2N) communication, and/or in-vehicle network (IVN) communication may be applied.

The communication portion 120 may receive map information corresponding to a position of a current vehicle from a server. The map information includes precision map and road information. The road information may include information such as autonomous driving levels, road attributes, traffic signals, traffic situations, road conditions, traffic signs, major buildings, and driving conditions of surrounding vehicles, for each road section (link).

The communication portion 120 may receive surrounding vehicle information from surrounding vehicles, and may receive traffic state information from surrounding traffic equipment.

The surrounding vehicle information may include surrounding vehicle ID, surrounding vehicle GPS position information, surrounding vehicle state information, and surrounding vehicle path history information, but is not limited thereto.

The surrounding vehicle state information may include vehicle speed information, heading information, brake operation information, and turn signal information, but is not limited thereto.

The traffic state information may include traffic light state information. Here, the traffic light state information may include a running state, a stop notice state, and a stop state, but is not limited thereto.

The user input portion 130 generates input data (for example, autonomous driving mode operation or release) according to the user's manipulation. The user input portion 130 may be implemented as a keyboard, a keypad, a button, a jog shuttle, a switch, a touch pad, and/or a touch screen. For example, the user input portion 130 generates a signal indicating activation of a specific control function (for example, lane maintenance, obstacle avoidance, collision avoidance, lane change, or acceleration/deceleration control) according to user input.

The memory 140 may store software programmed for the controller 190 to perform a predetermined operation, and may store input/output data. Furthermore, the memory 140 may store a precision map in a database format. The precision map may be automatically updated every predetermined transmission period or manually updated by the user. Furthermore, the memory 140 may store map information and road information.

The memory 140 may also store software programmed to perform specific control functions for performing a vehicle's cruise driving. For example, the memory 140 may store information on an inter-vehicle distance corresponding to a vehicle speed, information on a corrected speed corresponding to a speed limit, information on torque corresponding to RPM and APS, and the like.

The memory 140 may store vehicle identification information, and a maximum autonomous driving level (autonomous driving support level) which may be supported by the vehicle. The memory 140 may store reliability calculation algorithms, and software programmed to perform specific control functions to perform autonomous driving of the vehicle.

The memory 140 may be implemented as at least one or more of storage mediums (recording mediums) such as a flash memory, a hard disk, a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), a register, a detachable disk, and web storage.

The engine controller 150 controls an internal combustion engine according to an engine torque command determined by the controller 190. The engine controller 150 may be an engine management system (EMS).

The motor controller 160 controls an operation of a motor according to a motor torque command determined by the controller 190.

In a typical internal combustion engine vehicle, torque may be controlled by the engine controller 150, and in an electric vehicle, torque may be controlled by the motor controller 160. In a hybrid electric vehicle, the internal combustion engine may be controlled by the engine controller 150, and the starting generation motor and the driving motor may be controlled by the motor controller 160.

Embodiments may control the torque of the vehicle by use of at least one of the engine controller 150 and the motor controller 160 according to a type of vehicle.

The brake controller 170 controls the vehicle's deceleration. The braking controller 170 controls a braking pressure according to a brake pedal position or a braking pressure according to control of the controller 190.

The transmission controller 180 is configured to shift a gear (shifting stage) of the vehicle. The transmission controller 180 may be implemented as an electronic shifter or an electric shifter (shift by wire, SBW).

The controller 190 controls an operation (acceleration and deceleration, and/or braking) of the vehicle based on driving environment information and vehicle state information detected by the sensor portion 110. The controller 190 may be implemented as at least one or more of an application specific integrated circuit (ASIC), a digital signal processor (DSP), a programmable logic device (PLD), a field programmable Gate Array (FPGA), a central processing unit (CPU), a microcontroller, and a microprocessor.

The controller 190 obtains vehicle information from one or more sensors mounted on the vehicle in addition to the sensors described above in the sensor portion 110, and/or an electronic control unit (ECU) other than the various controllers 150, 160, 170, and 180. The one or more sensors may include an impact sensor, a steering angle sensor, and an acceleration sensor. The controller 190 may obtain vehicle information (for example, airbag deployment, door opening or closing) from various electronic control units (ECU) connected through the IVN. The IVN is implemented as a controller area network (CAN), a media oriented systems transport (MOST) network, a local interconnect network (LIN), and/or an X-by-wire (FlexRay).

The controller 190 may control the operations of the engine and the motor by determining whether the vehicle is in cruise driving while the vehicle is traveling. For example, when it is determined that cruise driving is to be performed based on data obtained from the sensor portion 110 and data collected by the communication portion 120, the controller 190 may reduce torque sensitivity of the engine and/or the motor according to an accelerator pedal opening amount.

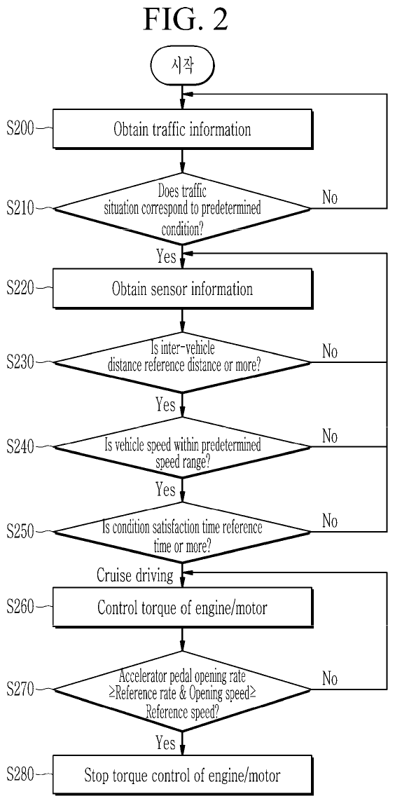

Hereinafter, referring to FIG. 2, a vehicle control method according to various exemplary embodiments of the present invention will be described.

FIG. 2 illustrates a flowchart of a vehicle control method according to various exemplary embodiments of the present invention.

The controller 190 obtains information received from the communication portion 120 (S200). For example, the controller 190 may obtain information on traffic situations, speed limit information, and the like from the communication portion 120 from map information received from a server, surrounding vehicles, and/or surrounding equipment.

The traffic situation includes information indicating at least one of a degree of congestion and presence or absence of an accident on a road on which the vehicle is currently positioned.

As shown in Table 1, the degree of congestion of the road may be classified into “smooth”, “slow”, and “congestion”, and “smooth”, “slow”, and “congestion” may be classified as different speed ranges depending on a type of road.

TABLE 1

| Degree of | General | National | Urban | |
|---|---|---|---|---|
| congestion | road | highway | highway | Highway |
| Congestion | Less than 15 | Less than 20 | Less than 30 | Less than 40 |
| | km/h | km/h | km/h | km/h |
| Slow | 15 km/h or | 20 km/h or | 30 km/h or | 40 km/h or |
| | more and | more and | more and | more and |
| | less than 30 | less than 40 | less than 60 | less than 70 |
| | km/h | km/h | km/h | km/h |
| Smooth | 30 km/h or | 40 km/h or | 60 km/h or | 70 km/h or |
| | more | more | more | more |

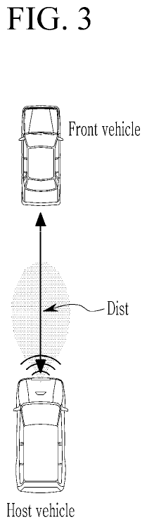

The controller 190 determines whether the traffic situation corresponds to a predetermined condition (S210). For example, the controller 190 may determine whether the traffic situation corresponds to “smooth” or “slow”. When the traffic situation corresponds to a predetermined condition, the controller 190 obtains information detected by the sensor portion 110 (S220). For example, the controller 190 may obtain information on the vehicle speed and the distance from the front vehicle from the sensor portion 110. In relation to the inter-vehicle distance, it will be described with reference to FIG. 3.

FIG. 3 illustrates a view of an inter-vehicle distance from a front vehicle.

As shown in FIG. 3, the driving environment sensor 116 mounted on the host vehicle can measure the inter-vehicle distance (Dist) from the front vehicle. For example, the driving environment sensor 116 may measure a relative inter-vehicle distance between the front vehicle and the host vehicle by use of a front radar signal. The driving environment sensor 116 may utilize front radar for smart cruise control (SCC) or various sensors such ultrasonic wave and laser sensors.

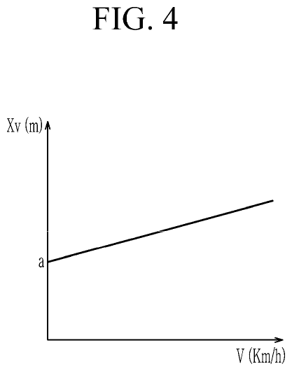

The controller 190 determines whether the inter-vehicle distance from the front vehicle is greater than or equal to a reference distance (S230). The reference distance may be a constant value, or may be a value which is changed according to the vehicle speed. Regarding the reference distance, it will be described with reference to FIG. 4.

FIG. 4 illustrates a graph of a reference inter-vehicle distance between vehicles with respect to a vehicle speed in a vehicle control method according various exemplary embodiments of the present invention.

As shown in FIG. 4, the reference inter-vehicle distance may increase according to the vehicle speed. For example, when the vehicle speed is 40 km/h, the reference inter-vehicle distance may be 40 m, and when the vehicle speed is 60 km/h, the reference inter-vehicle distance may be 60 m. Although FIG. 4 linearly illustrates the relationship between the vehicle speed and the reference inter-vehicle distance, this is only an example, and the present invention may include various relationships in which the reference inter-vehicle distance increases as the vehicle speed increases.

When the inter-vehicle distance from the front vehicle is greater than or equal to the reference inter-vehicle distance, the controller 190 determines whether the vehicle speed is within a predetermined speed range or not (S240). The predetermined speed range may be determined corresponding to the speed limit. The predetermined speed range may be a range between a speed value obtained by adding a first correction speed to a speed limit and a speed value obtained by subtracting a second correction speed from the speed limit, according to Equation 1.

Vs−Ve2<V<Vs+Ve1 (Equation 1)

Herein, V is a vehicle speed, Vs is a speed limit, Ve1 is a first correction speed, and Ve2 is a second correction speed.

In the above, the first correction speed and the second correction speed may have the same value, or may have different values. Furthermore, the first correction speed may be less than or equal to the second correction speed.

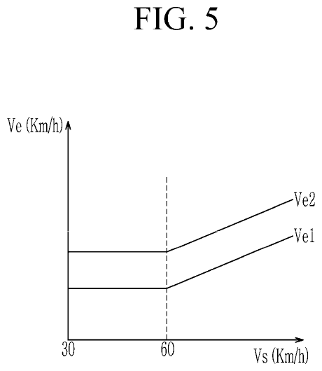

The predetermined speed range will be described with reference to FIG. 5.

FIG. 5 illustrates a graph of a corrected speed with respect to a speed limit in a vehicle control method according to various exemplary embodiments of the present invention.

As shown in FIG. 5, a correction speed for determining the predetermined speed range may be determined according to the speed limit of the road in which the vehicle is currently positioned.

When the speed limit is in a first section, the first correction speed and the second correction speed may be constant values. For example, when the speed limit is included in a section between 30 km/h to 60 km/h, the first correction speed may be 3 km/h, and the second correction speed may be 5 km/h.

When the speed limit is in a second section, the first correction speed and the second correction speed may be values that increase as the speed limit increases. For example, when the speed limit is 80 km/h, the first correction speed may be 4 km/h, and the second correction speed may be 8 km/h. When the speed limit is 100 km/h, the first correction speed may be 5 km/h, and the second correction speed may be 10 km/h.

When the vehicle speed is within the predetermined speed range, the controller 190 determines whether a time in which the vehicle speed is within the predetermined speed range is greater than or equal to a reference time (S250). When the time in which the vehicle speed is within the predetermined speed range is greater than or equal to the reference time, the controller 190 may determine a cruise driving state.

When it is determined as the cruise driving state, the controller 190 controls the engine and/or the motor so that the torque change corresponding to the opening rate of the accelerator pedal is small (S260). That is, so that the torque change corresponding to the opening rate of the accelerator pedal in the cruise driving state is smaller than the torque change corresponding to the opening rate of the accelerator pedal if not in the cruise driving state, the controller 190 may control the engine and/or the motor.

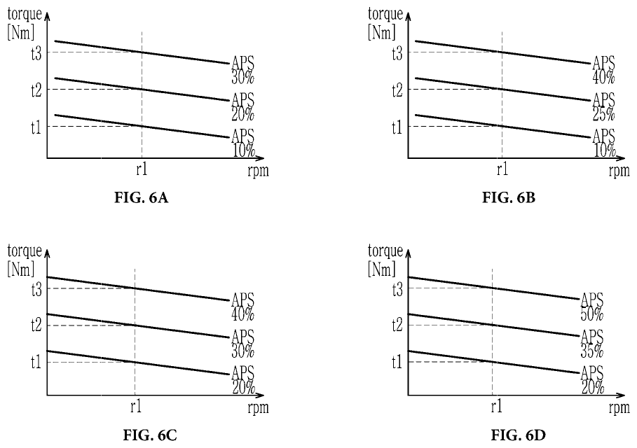

This will be described with reference to FIG. 6.

FIG. 6 illustrates graphs of torque with respect to RPM and APS in a vehicle control method of various exemplary embodiments of the present invention.

As shown in FIG. 6A, if not in the cruise driving state, and when rpm is r1 and the opening rate of the accelerator pedal is 10%, 20%, and 30%, the controller 190 generates an engine torque command and/or a motor torque command so that the torque of the engine and/or the motor are t1 Nm, t2 Nm, and t3 Nm, respectively, and the controller 190 transmits them to the engine controller 150 and/or the motor controller 160.

As shown in FIG. 6B, when in the cruise driving state, and when rpm is r1 and the opening rate of the accelerator pedal is 10%, 25%, and 40%, the controller 190 may generate an engine torque command and/or a motor torque command so that the torque of the engine and/or the motor are t1 Nm, t2 Nm, and t3 Nm, respectively, and may transmit them to the engine controller 150 and/or the motor controller 160.

That is, when the rpm is r1 in the cruise driving state, to change the vehicle torque from t1 Nm to t2 Nm, the opening rate of the accelerator pedal must be increased by 15% compared with if not in the cruise driving state. Therefore, so that the torque is not easily changed, that is, so that the sensitivity is reduced, to the driver's small input to the accelerator pedal, the controller 190 may control the engine and/or the motor. Accordingly, the cruise driving of the vehicle may be easily maintained.

As shown in FIG. 6C, when in the cruise driving state, and when rpm is r1 and the opening rate of the accelerator pedal is 20%, 30%, and 40%, the controller 190 may generate an engine torque command and/or a motor torque command so that the torque of the engine and/or the motor are t1 Nm, t2 Nm, and t3 Nm, respectively, and may transmit them to the engine controller 150 and/or the motor controller 160.

That is, when the rpm is r1 in the cruise driving state, to set the vehicle torque to t1 Nm, the opening rate of the accelerator pedal must be increased by 10% compared with if not in the cruise driving state. In the instant case, a difference in the opening rate for changing the torque is the same as if not in the cruise driving state. Therefore, even if the opening rate of the accelerator pedal is large, the resulting torque value is smaller than that if not in the cruise driving state, so it is possible to reduce the burden on the ankle of the driver who depresses the accelerator pedal.

As shown in FIG. 6D, when in the cruise driving state, and when rpm is r1 and the opening rate of the accelerator pedal is 20%, 35%, and 50%, the controller 190 may generate an engine torque command and/or a motor torque command so that the torque of the engine and/or the motor are t1 Nm, t2 Nm, and t3 Nm, respectively, and may transmit them to the engine controller 150 and/or the motor controller 160.

That is, when the rpm is r1 in the cruise driving state, to change the vehicle torque from t1 Nm to t2 Nm, the opening rate of the accelerator pedal may be increased by 15% compared with if not in the cruise driving state. Therefore, so that the torque is not easily changed, that is, so that the sensitivity is reduced, to the driver's small input to the accelerator pedal, the controller 190 may control the engine and/or the motor. Accordingly, the cruise driving of the vehicle may be easily maintained.

Furthermore, when the rpm is r1 in the cruise driving state, to set the vehicle torque to t1 Nm, the opening rate of the accelerator pedal must be increased by 10% compared with if not in the cruise driving state. In the instant case, a difference in the opening rate for changing the torque is the same as if not in the cruise driving state. Therefore, even if the opening rate of the accelerator pedal is large, the resulting torque value is smaller than that if not in the cruise driving state, so it is possible to reduce the burden on the ankle of the driver who depresses the accelerator pedal.

Thereafter, the controller 190 determines whether the opening rate of the accelerator pedal is greater than or equal to the reference opening rate, and whether the opening speed of the accelerator pedal is greater than or equal to the reference speed (S270).

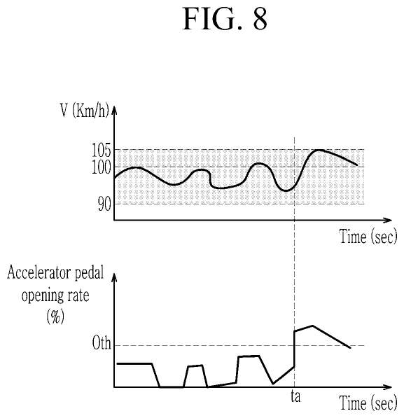

When the opening rate of the accelerator pedal is the reference opening rate or more and the opening speed of the accelerator pedal is the reference speed or greater, the controller 190 stops the engine and/or motor control according to the cruise driving state (S280). This will be described with reference to FIG. 8.

FIG. 8 illustrates a graph of an acceleration time point during cruise driving in a vehicle control method of various exemplary embodiments of the present invention.

As shown in FIG. 8, when the opening rate of the accelerator pedal is less than a reference opening rate (Oth), the controller 190 maintains the engine and/or motor control according to the cruise driving state. In the instant case, the vehicle speed may be within a predetermined speed range.

At time point ta, when the accelerator pedal opening rate is the reference opening rate (Oth) or more and the accelerator pedal opening speed is the reference speed or greater, the controller 190 may stop the engine and/or motor control according to the cruise driving state at the time point ta.

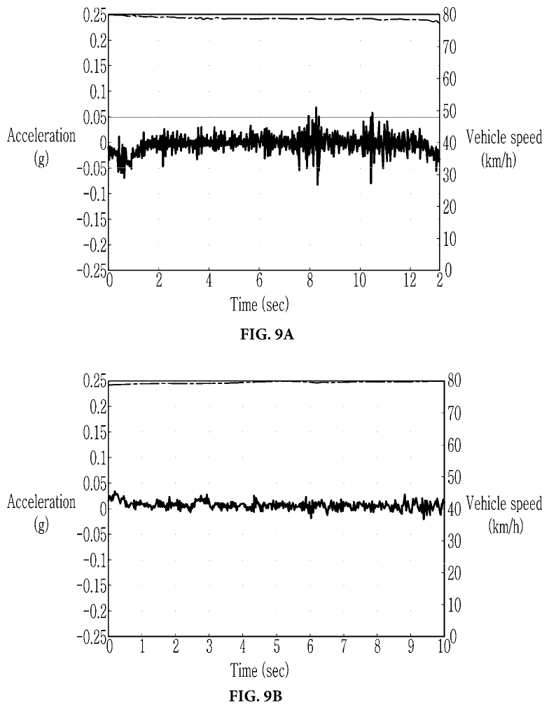

Hereinafter, an effect of the vehicle control apparatus and the vehicle control method according to the exemplary embodiments will be described with reference to FIG. 9.

FIG. 9 illustrates a graph of acceleration and vehicle speed of a vehicle traveling according to the vehicle control method of the embodiment.

As shown in FIG. 9A, when the vehicle is not in the cruise driving state, the driver should adjust the torque of the vehicle by depressing the accelerator pedal to maintain the constant vehicle speed. In the instant case, even if the change of the accelerator pedal is small, since the vehicle is controlled so that relatively large torque is outputted, the change in acceleration over time becomes large.

As shown in FIG. 9B, when the vehicle is in the cruise driving state, even if the change of the accelerator pedal is large, since the vehicle is controlled so that relatively small torque is outputted, the change in acceleration over time becomes small.

That is, the change in acceleration is due to the change in torque, and thus the torque control in the cruise driving state may increase the efficiency of fuel and/or electricity.

In the above, it has been described that the vehicle control apparatus and the vehicle control method are performed through the speed of the vehicle and/or traffic situations, but the driver may adjust the sensitivity of the torque change rate according to the accelerator pedal opening rate through the user input portion 130. That is, when the driver operates a button provided in the vehicle, the controller 190 may operate to have torque responses of FIG. 6B, FIG. 6C, and FIG. 6D.

It should be appreciated that Various embodiments of the present invention and the terms used therein are not intended to limit the technological features set forth herein to various exemplary embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, configured to perform one or more functions. For example, according to various exemplary embodiments of the present invention, the module may be implemented in a form of an application-specific integrated circuit (ASIC).

Various embodiments as set forth herein may be implemented as software (e.g., the program) including one or more instructions that are stored in a storage medium (e.g., internal memory or external memory) which is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in a form of a non-transitory storage medium. Here, the term “non-transitory” simply means that the storage medium is a tangible device, and does not include a signal (e.g., an electromagnetic wave), but the present term does not differentiate between where data is semi-permanently stored in the storage medium and where the data is temporarily stored in the storage medium.

According to various exemplary embodiments of the present invention, a method according to various embodiments of the present invention may be included and provided in a computer program product. The computer program product may be traded as a product between a seller and a buyer. The computer program product may be distributed in a form of a machine-readable storage medium (e.g., compact disc read only memory (CD-ROM)), or be distributed (e.g., downloaded or uploaded) online via an application store (e.g., Play StoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle control apparatus of a host vehicle, comprising:
a driving environment sensor that obtains information on a front vehicle;
a communication portion that receives traffic situation information; and
a controller that is electrically connected to the driving environment sensor and the communication portion and utilizes the information on the front vehicle and the traffic situation information to determine a cruise driving state of the host vehicle and that, when the host vehicle is in the cruise driving state, controls torque of the host vehicle so that a torque change corresponding to an opening rate of an accelerator pedal of the host vehicle becomes smaller than a predetermined value,
wherein the traffic situation information includes information indicating at least one of a degree of congestion and presence or absence of an accident on a road on which the host vehicle is positioned, and
wherein the controller is configured to determine the cruise driving state of the host vehicle upon determining that the degree of congestion according to a type of the road on which the host vehicle is positioned corresponds to a predetermined condition.

2. The vehicle control apparatus of claim 1, wherein the controller is configured to determine the cruise driving state of the host vehicle upon determining that a distance between the front vehicle and the host vehicle is greater than or equal to a reference distance.

3. The vehicle control apparatus of claim 1, further including
a vehicle speed sensor configured for detecting a speed of the host vehicle,
wherein the controller is configured to determine the cruise driving state of the host vehicle when the speed of the host vehicle is within a predetermined speed range.

4. The vehicle control apparatus of claim 3,
wherein the traffic situation information includes information on a speed limit of a road on which the host vehicle is positioned,
wherein the predetermined speed range includes a range between a speed value obtained by adding a first correction speed to the speed limit and a speed value obtained by subtracting a second correction speed from the speed limit, and
wherein the first correction speed and the second correction speed are determined corresponding to the speed limit.

5. The vehicle control apparatus of claim 4, wherein the first correction speed is less than or equal to the second correction speed.

6. The vehicle control apparatus of claim 4, wherein the first correction speed and the second correction speed increase as the speed limit increases.

7. The vehicle control apparatus of claim 6, wherein the first correction speed and the second correction speed have a constant value when the speed limit is less than a predetermined speed.

9. The vehicle control apparatus of claim 1, wherein the controller is configured to control the torque of the host vehicle so that a difference in an opening rate of the accelerator pedal corresponding to a difference between a first torque value and a second torque value in the cruise driving state is smaller than a difference in the opening rate of the accelerator pedal corresponding to a difference between the first torque value and the second torque value when the host vehicle is not in the cruise driving state.

9. The vehicle control apparatus of claim 1, wherein the controller is configured to control the torque of the host vehicle so that a torque value corresponding to a first opening rate of the accelerator pedal in the cruise driving state is smaller than a torque value corresponding to the first opening rate of the accelerator pedal when the host vehicle is not in the cruise driving state.

10. A vehicle control method of a host vehicle, comprising:
obtaining, by a driving environment sensor, information on a front vehicle;
receiving, by a communication portion, traffic situation information;
determining, by a controller electrically connected to the driving environment sensor and the communication portion, a cruise driving state of the host vehicle by use of the information on the front vehicle and the traffic situation information; and
controlling, by the controller, torque of the host vehicle when the host vehicle is in the cruise driving state so that a torque change corresponding to an opening rate of an accelerator pedal of the host vehicle becomes smaller than a predetermined value,
wherein the traffic situation information includes information indicating at least one of a degree of congestion and presence or absence of an accident on a road on which the host vehicle is positioned, and
wherein the determining of the cruise driving state of the host vehicle includes determining the cruise driving state upon determining that the degree of congestion according to a type of the road on which the host vehicle is positioned corresponds to a predetermined condition.

11. The vehicle control method of claim 10,
wherein the determining of the cruise driving state of the host vehicle includes, determining the cruise driving state when a distance between the front vehicle and the host vehicle is greater than or equal to a reference distance.

12. The vehicle control method of claim 10, further including
detecting, by a vehicle speed sensor electrically connected to the controller, a speed of the host vehicle,
wherein the determining of the cruise driving state of the host vehicle includes, determining the cruise driving state when the speed of the host vehicle is within a predetermined speed range.

13. The vehicle control method of claim 12,
wherein the traffic situation information includes information on a speed limit of a road on which the host vehicle is positioned,
wherein the predetermined speed range includes a range between a speed value obtained by adding a first correction speed to the speed limit and a speed value obtained by subtracting a second correction speed from the speed limit, and
wherein the first correction speed and the second correction speed are determined corresponding to the speed limit.

14. The vehicle control method of claim 13, wherein the first correction speed is less than or equal to the second correction speed.

15. The vehicle control method of claim 13, wherein the first correction speed and the second correction speed increase as the speed limit increases.

16. The vehicle control method of claim 13, wherein the first correction speed and the second correction speed have a constant value when the speed limit is less than a predetermined speed.

17. The vehicle control method of claim 13, wherein the controlling of the torque of the host vehicle includes controlling the torque of the host vehicle so that a difference in an opening rate of the accelerator pedal corresponding to a difference between a first torque value and a second torque value in the cruise driving state is smaller than a difference in the opening rate of the accelerator pedal corresponding to a difference between the first torque value and the second torque value when the host vehicle is not in the cruise driving state.

18. The vehicle control method of claim 13, wherein the controlling of the torque of the host vehicle includes controlling the torque of the host vehicle, so that a torque value corresponding to a first opening rate of the accelerator pedal in the cruise driving state is smaller than a torque value corresponding to the first opening rate of the accelerator pedal when not in the cruise driving state sheet.

19. The host vehicle including the vehicle control apparatus of claim 1.

20. A computer-readable medium on which a program for executing the vehicle control method of claim 10 is recorded.
